(19) United States
(12) Patent Application Publication
(10) Pub. No.: US 2008/0271814 A1
(43) Pub. Date: Nov. 6, 2008

(54) Honeycomb Flame Arrester and Flow Straightener for a Fuel System Fuel Fill Pipe

(75) Inventors: Terry R. Wilton, Waterford, MI (US); Donald H. Courtley, Shelby Township, MI (US); Ryan C. Ratchford, Novi, MI (US); Timothy J. Spry, Rochester Hills, MI (US); Daniel J. Maurer, Novi, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/744,356

(22) Filed: May 4, 2007

(51) Int. Cl. B65B 1/04; B60K 15/04; A62C 3/06; A62C 3/07

(52) U.S. Cl. 141/285; 169/62; 169/66

(57) ABSTRACT

A motor vehicle filler pipe flame arrester and fuel flow straightener configured to effectively quench a moving flame front, while providing laminar fuel flow therethrough. A multi-channel (or multi-cell) configuration, most preferably a honeycomb configuration, provides effective flame arresting due to its heat sink capacity and large effective surface area for flame arrestment, while attendantly limiting availability of fuel and oxygen to the flame, thereby providing quenching of a flame wave as it propagates through the channels. Service station pump nozzle shut-off sensor disruption is avoided because the channels encourage laminar flow of the fuel through the multi-channel filler pipe flame arrester and fuel flow straightener.

### TECHNICAL FIELD

The present invention relates to flame arresters or flame check devices for use in preventing a flame front from passing through a filler pipe into a flammable liquid storage tank, and more particularly to a flame arrester for use in filler pipes of motor vehicles which also provides fuel flow straightening.

### BACKGROUND OF THE INVENTION

A flame arrester is a passive device that allows the flow therethrough of fuel, or other flammable liquids, but prevents any external flame or flashback (backfire) from passing along the current flow of the fuel or other flammable liquid flow into the storage tank therefor. If such a flashback is not prevented, the storage tank of fuel or other flammable liquid could ignite with undesirable consequences.

The design of flame arresters in motor vehicle applications must take into account the means and mechanism of refueling. As can be understood by reference to FIG. 1, a fuel filler pipe assembly 10 includes a filler pipe 12 connected to at least one fuel tank 14, a nozzle entry chamber 16 which has a generally cylindrical shape of a diameter much larger than that of the filler pipe, and a filler neck 18 which has a generally frustoconical shape that provides interfacing between the filler pipe and the nozzle entry chamber. The nozzle entry chamber 16 has a threaded opening 20 for threadably receiving a selectively removable filler cap (also frequently referred to as a gas cap) 22 and further has a nozzle guide orifice 24 internally disposed in the nozzle entry chamber in spaced relation with respect to the threaded opening. The fuel filler pipe assembly 10 is interfaced with the vehicular body 26 by connection thereto at the nozzle entry chamber 16. The filler pipe 12 is composed of a flexible pipe wall 34, as for example rubber or other suitable material.

In operation, a service station customer unthreads the filler cap 22 inserts the service station fuel pump nozzle 28 (see the phantom outline in FIG. 1) into the nozzle entry chamber 16 so that it passes through the nozzle guide orifice 24, and then begins fueling of the motor vehicle. The fueling process is automatically regulated by a fuel shut-off sensor 30 in the pump nozzle. The fuel shut-off sensor 30 senses predetermined differential pressure between the fluid pressure of fuel exiting the pump nozzle 28 and the fuel pressure at an aspirator hole 32 formed in the side of the pump nozzle so that the fuel flow will be automatically shut-off before the fuel can accumulate sufficiently such as to overflow the fuel filler pipe.

Problematically, the fuel shut-off sensor can cause premature shut-off of fuel flow from the pump nozzle at any time during the fueling process, even at the initial stage thereof, if an erroneous differential fluid pressure between the aspirator hole and the fuel exiting the pump nozzle is sensed by the fuel shut-off sensor. One way in which this can occur is if there is a reverse circulation of fuel (that is, a turbulent fuel flow) exiting the pump nozzle 28 in a nozzle engagement zone 36 of the filler pipe 12.

A conventional filler pipe flame arrester 38 for motor vehicle applications, shown at FIGS. 1 and 1A, is affixed to the inside wall surface 34a of the pipe wall 34 of the filler pipe, and is composed of a hemispherically shaped hollow shell of metallic screen which provides adequate flame arresting in the filler pipe 12. This is accomplished by the conventional filler pipe flame arrester 38 serving as a heat sink which absorbs heat from the flame front so as to thereby limit its progress therepast, as well as by disrupting the flow of oxygen and fuel to the flame front as it passes therethrough.

A problem of the screen composition of the conventional filler pipe flame arrester 38 is that the interaction of the fuel flow with the screen can upset the orderly function of the shut-off sensor during normal refilling of motor vehicle fuel tanks. As shown at FIG. 1A, a nozzle end portion 28a of the pump nozzle 28 is placed into the filler neck at the nozzle engagement zone 36. Fluid flow F exiting the pump nozzle strikes the conventional filler pipe flame arrester 38, which, in turn, results in fuel flow turbulence which is manifested by a reverse circulation fuel flow F′. The reverse circulation fuel flow F′ causes increased fluid pressure at the aspirator hole 32 of the fuel shut-off sensor of the pump nozzle to be undesirably sensed by the fuel shut-off sensor as higher than if the reverse fuel circulation were not present. This sensed untoward higher pressure can lead to premature shut-off of fuel flow from the pump nozzle, thus disrupting the fueling process. Additionally, turbulence may produce fuel flow cavitation that allows for the build up of vapors in the region of the fuel flow which can also contribute to the production of back pressure and thereby enhance the chance of premature fuel shut-off.

Accordingly, what remains needed in the art is a filler pipe flame arrester designed in such a way so as to effectively quench a moving flame front or flashback (backfire) and external flame source propagation through a motor vehicle filler pipe, while not producing turbulence induced reverse circulation fuel flow which would create premature shut-off of fuel flow at the pump nozzle.

### SUMMARY OF THE INVENTION

The present invention is a motor vehicle filler pipe flame arrester and fuel flow straightener configured in such a way as to be an effective quench for a moving flame front or flashback (backfire) and external flame source propagation through the motor vehicle filler pipe, while not producing turbulence induced reverse circulation fuel flow which would create premature shut-off of fuel flow at the pump nozzle. In this regard, the present invention utilizes a multi-channel (or multi-cell) configuration, most preferably a honeycomb configuration, in order to provide an effective fuel flow flame arrester while at the same time facilitating laminar fuel flow during the filling of the fuel tank of the motor vehicle.

The multi-channel filler pipe flame arrester and fuel flow straightener according to the present invention provides effective flame arresting in motor vehicle applications for several reasons. Firstly, the sidewalls of the multi-channels of the present invention serve as a more effective heat sink than the screen of the conventional filler pipe flame arrester described hereinabove. The most preferred channel configuration, a honeycomb, serves to increase the effective surface area for flame arresting, thereby absorbing more heat from the flame front, whereby a flame is extinguished as the flame front cools while passing through the channels. Additionally, through optimization of the channel cross-section, the honeycomb design limits the availability of fuel and oxygen to the flame, thereby quenching the flame wave as it propagates through the channels. Lastly, the present invention does not produce shut-off sensor disruption during the fueling of a motor vehicle, as can otherwise happen with conventional filler pipe flame arrestors, as described hereinabove. This is because the channels of the present invention, particularly the honeycomb configuration thereof, encourages laminar flow of the fuel through the multi-channel filler pipe flame arrester and fuel flow straightener, which thereby eliminates turbulence in the fuel flow. This laminar fuel flow prevents excess vapor generation, reduces the backpressure of the fuel, and lessens the likelihood of premature shut-off of fuel flow at the pump nozzle.

Accordingly, it is the object of the present invention to provide a multi-channel filler pipe flame arrester and fuel flow straightener for a motor vehicle filler pipe, configured to provide an effective quench for flame flashback (backfire) and external flame source propagation through the filler pipe, while at the same time encouraging laminar fuel flow therethrough, whereby the chance of premature shut-off of fuel flow at the pump nozzle is lessened.

This and additional objects, features and advantages of the present invention will become clearer from the following specifications of a preferred embodiment.

### BRIEF DESCRIPTION OF THE DRAWINGS

FIG. 1 is a partly sectional side view of a prior art fuel filler pipe, equipped with a conventional filler pipe flame arrester.

FIG. 1A is a broken away, sectional view of a service station fuel pump nozzle inserted filler neck of the fuel filler pipe of FIG. 1, showing the creation of reverse circulation fuel flow in the normal operation of a conventional fuel filler pipe equipped with a conventional filler pipe flame arrester.

FIG. 2 is a partly sectional side view of a fuel pipe incorporating the multi-channel filler pipe flame arrester and fuel flow straightener according to the present invention.

FIG. 3 is an end view of the multi-channel filler pipe flame arrester and fuel flow straightener according to the present invention.

FIG. 4 is an operational cross-sectional view of the filler pipe and the multi-channel filler pipe flame arrester and fuel flow straightener according to the present invention, seen along line 4-4 in FIG. 2.

### DESCRIPTION OF THE PREFERRED EMBODIMENT

Referring now to the Drawing, FIGS. 2 through 4 depict various aspects of structure and functional application of a multi-channel filler pipe flame arrester and fuel flow straightener 100 according to the present invention.

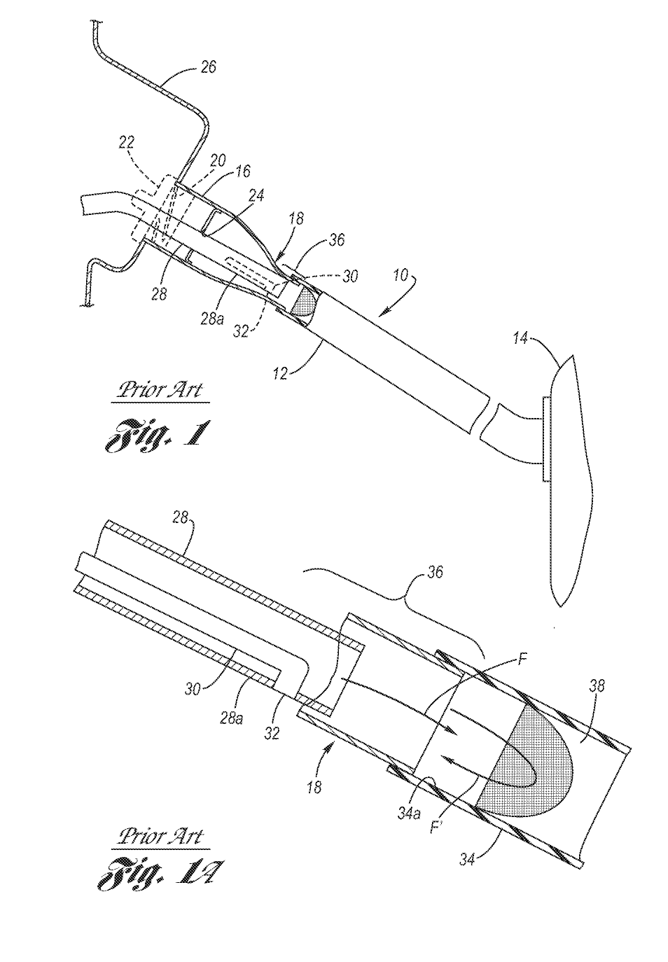

FIG. 2 operationally depicts the multi-channel filler pipe flame arrester and fuel flow straightener 100 located in a filler pipe 102 of a filler pipe assembly 104. In this regard, and in concert with the description with respect to FIG. 1, the otherwise conventional filler pipe 102 is connected at one end to at least one fuel tank 106 and at the other end to a frustoconically shaped metal filler neck 108 which, in turn connects to a generally cylindrically shaped metal nozzle entry chamber 110. The nozzle entry chamber 110 carries a metal nozzle guide orifice 112 which aids in the placement therein of a pump nozzle 28 by the service station customer, and thereby serves as an interface between the pump nozzle and the filler pipe 102. The filler pipe assembly 104 is interfaced with the vehicle body 114 by connection thereto at the nozzle entry chamber 110. The filler pipe 102 is formed of a flexible pipe wall 118, as for example a rubber material or other suitable material known in the art.

Operationally with respect to fueling the motor vehicle, the nozzle end portion 28a of the pump nozzle 28 is placed by the service station customer into the filler neck 108, and when fully inserted, the terminous of nozzle end portion is situated within the nozzle engagement zone 116, as shown at FIG. 2. Located within the filler pipe 102 and spaced adjacently to the nozzle engagement zone 116, is the multi-channel filler pipe flame arrester and fuel flow straightener 100 according to the present invention.

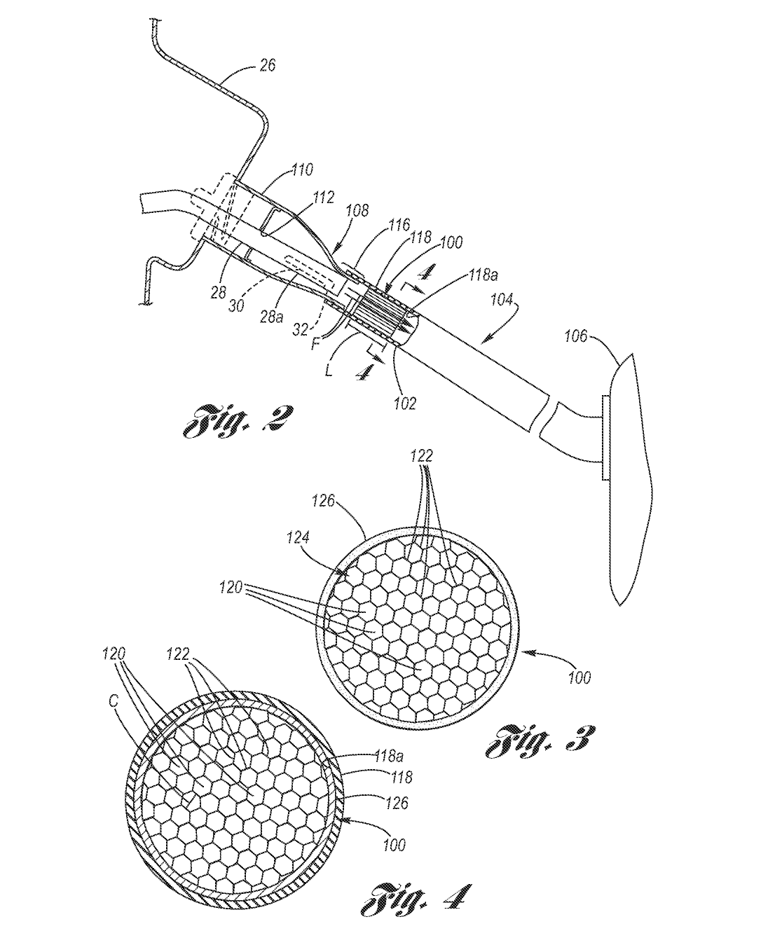

The multi-channel filler pipe flame arrester and fuel flow straightener 100 is composed of a multiplicity of the channels 120 across the cross-section of the filler pipe 102, as shown at FIG. 3. Each of the channels 120 provides a discrete, separate conduit for flow therethrough of fuel being dispensed from the pump nozzle 28. In this regard, it is desired to have the adjoining sidewall 122 of adjoining channels to mutually share the sidewall, and further arrange the channels 120 in an over-all compact pattern. While it is possible to shape the cross-sections of the channels 120 into any selected shape, as for example a triangular or polygonal shape, it is most preferred for the shape of the cross-sections to be hexagonal, whereby the pattern is that of a honeycomb 124, which is well known to be a compact pattern of touching shapes, as depicted at FIG. 3.

As mentioned hereinabove, the fuel pump nozzle 28 contains a fuel shut-off sensor 30 which employs an aspirator hole 32 to aid in the regulation of the fuel flow rate through monitoring the differential pressure at the nozzle 28 and the aspirator hole 32. The fuel flow exiting the nozzle F enters the nozzle engagement zone 116. This fuel flow is essentially laminar in nature, as it is unobstructed immediately upon exiting the pump nozzle. The fuel flow proceeds through the nozzle engagement zone 36 and encounters the channels 120 of the multi-channel filler pipe flame arrester and fuel flow straightener 100. In that the sidewalls 122 of the channels 120 are very thin (on the order of 0.001 inch) in comparison to the cross-section C of the individual channels (on the order of 0.125 inch), the channels afford a direct and unimpeded path for the fuel flow, which remains laminar therethrough and thereoutfrom. Accordingly, there is no fuel flow turbulence as occurs with the conventional filler pipe flame arresters used in the prior art; there is no reverse circulation fuel flow and no pressure imbalance that could cause the fuel shut-off sensor to prematurely shut-off fuel flow.

Referring with particularity to FIG. 3, it is seen that the sidewalls 122 are very thin in relation to the cross-section C of the channels 120, and further that the channel sidewalls are mutually shared among adjoining channels in a compact honeycomb pattern arrangement provided by the channels being of hexagonal shape. It is preferred, by way of example, that the cross-section (also referred to as cell size) C of the channels be constant along the length L (see FIG. 2) of the multi-channel filler pipe flame arrester and fuel flow straightener 100, preferably one-eighth inch; however, the size may for example range between one-sixteenth inch and one-quarter inch, depending upon the particular application. A preferred length L (see FIG. 2) of the multi-channel filler pipe flame arrester and fuel flow straightener 100 is between about 1 and 2 inches. While the sidewalls 122 may be constructed of any suitable metal having strength, heat resistance and good thermal conductivity, the most preferred material for reasons of cost, weight and serviceability is aluminum, most preferably of 5056 aluminum or 5052 aluminum, although other metals could be used, as for example stainless steel.

As shown at FIG. 4, a cylindrical sleeve 126, preferably of stainless steel, is circumferentially disposed with respect to the multiplicity of sidewalls 122 constituting the multi-channel filler pipe flame arrester and fuel flow straightener 100 and is affixed thereto, as for example by brazing. The sleeve 126 is then engaged with the inside pipe wall surface 118a of the pipe wall 118 of the filler pipe 102 by resilient press-fit with respect to the flexibility of the pipe wall or by other affixment modality.

To those skilled in the art to which this invention appertains, the above described preferred embodiment may be subject to change or modification. Such change or modification can be carried out without departing from the scope of the invention, which is intended to be limited only by the scope of the appended claims.

1. A filler pipe assembly for providing a conduit for fueling at least one tank of a motor vehicle, comprising:
a filler pipe; and
a flame arrester and fuel flow straightener comprising a multiplicity of sidewalls defining a multiplicity of channels arranged in a predetermined pattern, wherein each channel comprises a predetermined geometric shape defined by said sidewalls;
wherein said flame arrester and fuel flow straightener is connected with said filler pipe such that fuel flowing through said filler pipe also passes through said channels.

2. The filler pipe assembly of claim 1, wherein said geometric shape is a hexagon, and wherein said predetermined pattern is a honeycomb.

3. The filler pipe assembly of claim 1, wherein said channels have a length of between substantially one inch and two inches.

4. The filler pipe assembly of claim 3, wherein said geometric shape is a hexagon, wherein said predetermined pattern is a honeycomb, and wherein adjoining channels mutually share a respective sidewall.

5. The filler pipe assembly of claim 1, wherein said flame arrester and fuel flow straightener further comprises a sleeve circumferentially disposed with respect to said multiplicity of sidewalls, wherein said sleeve is attached to said multiplicity of sidewalls, and wherein said sleeve is affixed to an inside surface of said filler pipe.

6. The filler pipe assembly of claim 5, wherein said geometric shape is a hexagon, and wherein said predetermined pattern is a honeycomb.

7. The filler pipe assembly of claim 6, wherein said channels have a length of between substantially one inch and two inches.

8. The filler pipe assembly of claim 5, further comprising a filler neck connected to said filler pipe, wherein a nozzle engagement zone of said filler pipe is defined substantially adjacent said filler neck, and wherein said flame arrester and fuel flow straightener is disposed substantially adjacent said nozzle engagement zone.

9. The filler pipe assembly of claim 8, wherein said geometric shape is a hexagon, and wherein said predetermined pattern is a honeycomb.

10. The filler pipe assembly of claim 9, wherein said channels have a length of between substantially one inch and two inches.

11. A filler pipe assembly for fueling at least one tank of a motor vehicle, comprising:
a filler pipe having a cross-section; and
a flame arrester and fuel flow straightener located within said filler pipe, said flame arrester and fuel flow straightener comprising a multiplicity of sidewalls defining a multiplicity of channels arranged in a predetermined pattern across said cross-section, wherein each channel comprises a predetermined geometric shape defined by said sidewalls.

12. The filler pipe assembly of claim 11, wherein said geometric shape is a hexagon, and wherein said predetermined pattern is a honeycomb.

13. The filler pipe assembly of claim 11, wherein said channels have a length of between substantially one inch and two inches.

14. The filler pipe assembly of claim 13, wherein said geometric shape is a hexagon, wherein said predetermined pattern is a honeycomb, and wherein adjoining channels mutually share a respective sidewall.

15. The filler pipe assembly of claim 11, wherein said flame arrester and fuel flow straightener further comprises a sleeve circumferentially disposed with respect to said multiplicity of sidewalls, wherein said sleeve is attached to said multiplicity of sidewalls, and wherein said sleeve is affixed to an inside surface of said filler pipe.

16. The filler pipe assembly of claim 15, wherein said geometric shape is a hexagon, and wherein said predetermined pattern is a honeycomb.

17. The filler pipe assembly of claim 16, wherein said channels have a length of between substantially one inch and two inches.

18. The filler pipe assembly of claim 15, further comprising a filler neck connected to said filler pipe, wherein a nozzle engagement zone of said filler pipe is defined substantially adjacent said filler neck, and wherein said flame arrester and fuel flow straightener is disposed substantially adjacent said nozzle engagement zone.

19. The filler pipe assembly of claim 18, wherein said geometric shape is a hexagon, and wherein said predetermined pattern is a honeycomb.

20. The filler pipe assembly of claim 19, wherein said channels have a length of between substantially one inch and two inches.
